(19) United States
(12) Patent Application Publication
(10) Pub. No.: US 2002/0130770 A1
(43) Pub. Date: Sep. 19, 2002

(54) Object sensor with integrally molded housing and method for making same

(76) Inventors: Dennis Keyworth, Grand Blanc, MI (US); Julien Renaud, Pharr, TX (US); Efrain Dominguez, Pharr, TX (US); Thomas R. Daniel, Waterford, MI (US)

Correspondence Address: ANDREW R. BASILE, YOUNG & BASILE, P.C., SUITE 624, 3001 WEST BIG BEAVER ROAD, TROY, MI, 48084-3107, US

(21) Appl. No.: 09/750,752

(22) Filed: Dec. 29, 2000

(51) Int. Cl. B60Q 1/00

(52) U.S. Cl. 340/436; 340/435

(57) ABSTRACT

A sensor such as a proximity sensor or object device which has transceiver means for transmitting a signal and receiving a return signal reflected off of an object within a range of the transceiver means and a thermoplastic compound surrounding and directly contacting a portion of at least the transceiver means. The thermoplastic compound is a melt processible injection moldable material such as thermoplastic polyamides, thermoplastic polyesters, acetal resins, as well as mixtures of these materials.

### BACKGROUND OF THE INVENTION

This invention relates, in general, to an object sensor having an overmolded housing or sensors and various electronic devices encapsulated therein.

It has been known to provide one or more proximity detectors on the rear bumper and/or front and/or anywhere on the perimeter of a vehicle to detect an object within the perimeter of the vehicle where the vehicle or obstacle is in motion. Such devices are coupled with a control unit which calculates a distance measurement to the detected object and activates an audible alarm or series of lights and/or camera/monitor to provide an indication of the distance to the detected object.

Typically, the plurality of proximity detectors are mounted on the rear of the vehicle to cover an area slightly approximately as wide as the width of the vehicle. Generally, such proximity detectors are in the form of ultrasonic transceivers which transmit/receive an ultrasonic signal which is reflected by an object within the range of the transceiver. A suitable processing circuit determines the time between the transmission of the signal and the return of a reflected signal which is used to determine the distance to the detected object.

In the case of the ultrasonic sensors, ice and snow build up on the bumper covering a portion or all of the outer surface of the ultrasonic transceiver, interfering with the transmission and reception of ultrasonic waves which renders the object detector inoperative.

Typically such object sensors are contained within a housing containing potting compounds such as polyurethane potting compounds or similar polymeric compounds. These compounds are typically thermosetting materials which must be cured typically by exposure to heat with exposures up to 5 hours or more being possible. The compounds employed may not have the desired resilience or flexibility or temperature stability. However such materials have been considered necessary for use with object sensors/proximity detectors because potting material protects vital components from the elements. Additionally, the purity of the thermosetting polymeric resin compound must be maintained in order to insure the ultimate performance characteristics of the finished molded part. This makes the raw material more costly and minimizes the opportunity to integrate pre-consumer and post-consumer regrind polymeric resin into the formulation.

It is an object of the present invention to provide an assembly method and material which can eliminate the need for an outer housing assembly in some configurations or, at a minimum provide a secure integration between outer housing and interior material where the housing remains necessary. It is also an object that construction of the object sensor/proximity detector be possible without requiring extended cure times or intervals typically required with thermosetting resins. It is a further object of the present invention to provide an object sensor/proximity device which advantageously flexibly binds to a large number/type of different components. Yet further, it is an object of the present invention to provide a material which is satisfactorily operative over a broad temperature range. It is an object of this invention, in one embodiment, to provide an optical sensor/proximity device which comprises and an external housing and a thermoplastic polymeric material contained therein which overmolds selected electronic components. Alternately, it is an object of the invention to provide an integral housing by direct encapsulation of electronic components.

Further, it is an object of the present invention to provide a vehicle exterior object sensor with means to remove any ice or snow on the sensor mount. It is also an object of the present invention to provide a vehicle exterior object detector in which such means are easily incorporated in the sensor mount without requiring extensive modification to existing sensor designs.

Finally, it is an object of the present invention to provide a process for the formulation of object detectors and proximity sensors which will result in faster construction cycles and fewer secondary processing operations over traditional potting materials.

### SUMMARY OF THE INVENTION

The present invention addresses and solves the above-mentioned problems and meets the enumerated objects and advantages, as well as others not enumerated, by providing a sensor, comprising transceiver means for transmitting a signal and receiving a return signal reflected off of an object within a range of the transceiver means. A moldable thermoplastic compound surrounds the transceiver means. In one embodiment, moldable thermoplastic compound is contained within a suitable outer housing. In an alternate embodiment, the transceiver is encased directly in a suitable thermoplastic material which forms a suitable encasement housing.

The present invention further comprises an improved sensor apparatus for detecting an object exterior to a vehicle. Means are provided for mounted the transceiver on a support surface, such as the front and/or rear bumper and/or anywhere about the perimeter of a vehicle. Means are carried on the mounting means for elevating the temperature of the mounting means to remove ice and snow from the transceiver for proper operation of the transceiver.

In a preferred embodiment, the transceiver transmits an ultrasonic signal. The mounting means is in the form of the molded housing carrying the active components of the transceiver. A holder means is, preferably, integrally formed with the molded housing for mounting the molded housing to a support surface, such as any of the front and/or rear bumper and or anywhere on the perimeter of a vehicle.

The means for elevating the temperature of the mounting means preferably comprises heating means carried on the housing for heating at least a portion of the housing surrounding the end surface of the transceiver. In one embodiment, the heating means comprises a resistive coil embedded (or carried on) in the enlarged diameter flange or the holder. In another embodiment, the heating means comprises a resistive film embedded within or carried on the enlarged diameter flange of the holder. In a third embodiment, heating means is due to the conductive nature of the outer housing material.

The apparatus of the present invention uniquely provides a means for providing an integral assembly in which a suitable thermoplastic material functions as and replaces traditional potting material in an electronic housing such as an object sensor or proximity detector, thereby eliminating the need to cure or cross link traditional thermosetting potting material.

Thermoplastic materials have typically not been employed as overmolding or encapsulating materials with electronic assemblies such as proximity sensors because it was a widely held belief that the temperatures required to melt thermoplastic materials in order to introduce them into contact with the electronic desired electronic assembly, would damage delicate electronic components.

The apparatus of the present invention uniquely provides means for providing an integral encapsulated assembly in which the terminals and electronics contained in the traditional base section of the device are encapsulated with a suitable thermoplastic material to form an outer shell and connector recess. The membrane subassembly can be insert molded with the base portion and is isolated from the cap member by means of a rubber ring.

The apparatus of the present invention further uniquely provides a means of removing an exterior build up of ice and/or snow on the exterior portions of the transceiver and/or the holder to enable proper operation of the transceiver in all environmental conditions. The heating means is conveniently mounted on the enlarged flange of the holder without requiring extensive modification to existing sensor and sensor holder designs.

Other objects, advantages and applications of the present invention will become apparent to those skilled in the art when the following description of the best mode contemplated for practicing the invention is read in conjunction with the accompanying drawings.

### BRIEF DESCRIPTION OF THE DRAWINGS

The various features, advantages and other uses of the present invention will become more apparent by referring to the following detailed description and drawing in which:

FIG. 1 is a perspective view of a vehicle exterior object sensor according to the present invention;

FIG. 2 is an exploded, perspective view of the transceiver portion of the vehicle exterior object sensor of the present invention;

FIG. 3 is an exploded, perspective view showing the transceiver and mounting holder;

FIG. 4 is an exploded, bottom elevational view of the transceiver and mounting holder shown in FIG. 3;

FIG. 5 is a perspective view of one embodiment of the mounting holder shown in FIGS. 3 and 4;

FIG. 6 is a cross-sectional view generally taken along line 6-6 of FIG. 1;

FIG. 7 is a perspective view of another embodiment of a mounting holder according to the present invention; and

FIG. 8 is a schematic, block diagram of the control for the heated vehicle exterior object detector of the present invention.

### DESCRIPTION OF THE PREFERRED EMBODIMENT

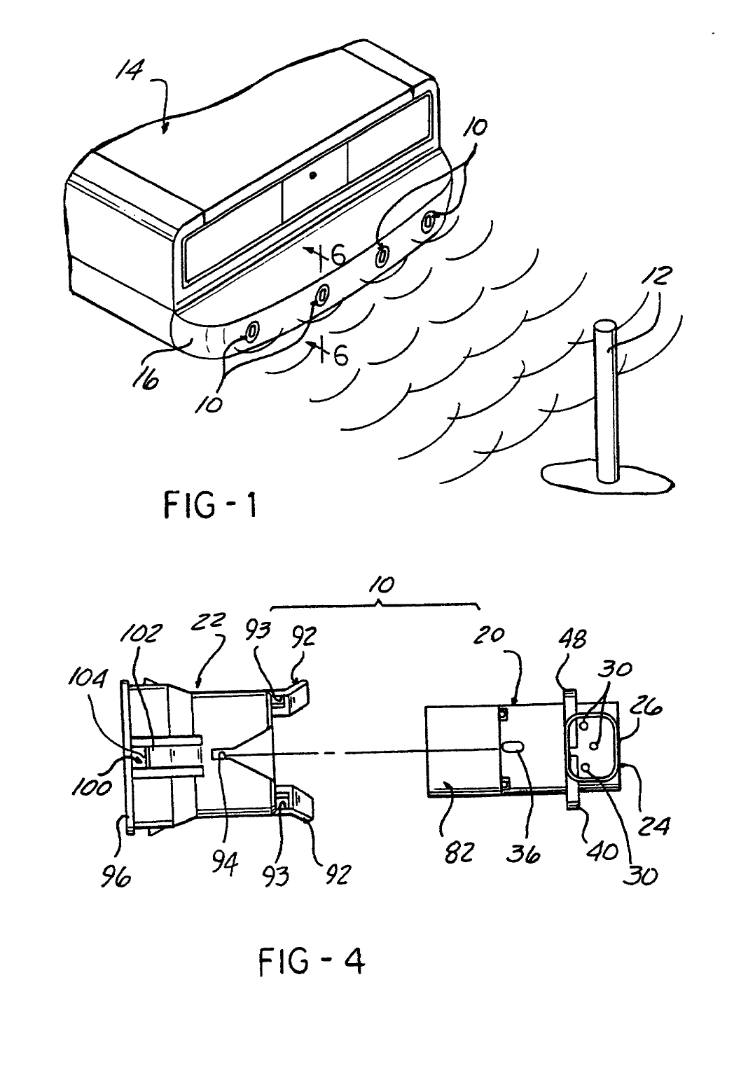

Referring now to the drawing, and to FIGS. 1-8 in particular, there is depicted a vehicle exterior object detector/proximity device 10, which is adapted for detecting and providing an indication of object 12 to the front and/or the rear and/or anywhere within the perimeter of a vehicle 14.

Preferably, a plurality of identical detectors 10 are mounted on one or both of the front bumper and the rear bumper 16 of the vehicle and laterally spaced apart along the length of the bumper 16 to provide a combined detection range approximately as wide as the length of the bumper 16. Although the drawing depicts a rear bumper 16, it will be understood herein that the sensor apparatus of the present invention can also be mounted on a front bumper of the vehicle, or on any surface about the perimeter of the vehicle.

The exterior object detector 10 is formed of a transceiver housing 20 and a transceiver mounting means or mount 22. In the first embodiment of the present invention, the housing 20 is formed of an assembly of components including a one piece base 24 which has a hollow, tubular portion 26 and an integral, generally perpendicularly extending concave portion 28. In the second embodiment of this invention, the housing 20 is integrally formed with the encapsulating thermoplastic material in a manner to be described subsequently. In either embodiment, a plurality of terminals, all denoted by reference number 30, are inserted molded within the tubular portion 26 to provide connections between the operative elements of the transceiver mounted within the interior of housing 20 and external electrical connections (not shown).

The concave portions 26 is formed with a pair of parallel edges 32 and 34 at an upper end which have grooves extending therealong. A projection 36 is formed adjacent to one end of each groove 32 and 34, the purpose of which will be described in greater detail hereafter. As shown in FIG. 4, a key projection 36 extends outwardly from a lower surface of the concave portion 28 for keying the orientation of the housing 20 to the holder or mount 22, as also described hereafter.

A cover 50 also has a concave shape, generally complementary to the concave portion 28 of the base 24. Parallel side edges 52 and 54 are engagable with the edges 32 and 34 of the concave portion 28. A recess formed in each edge 52 and 54 is engagable with one projection 36 on the edges 32 and 34 to align the cover 50 with the base 24. The cover 50 is fixedly mounted on the base 24 by means of a slide and latch or other suitable fastening means.

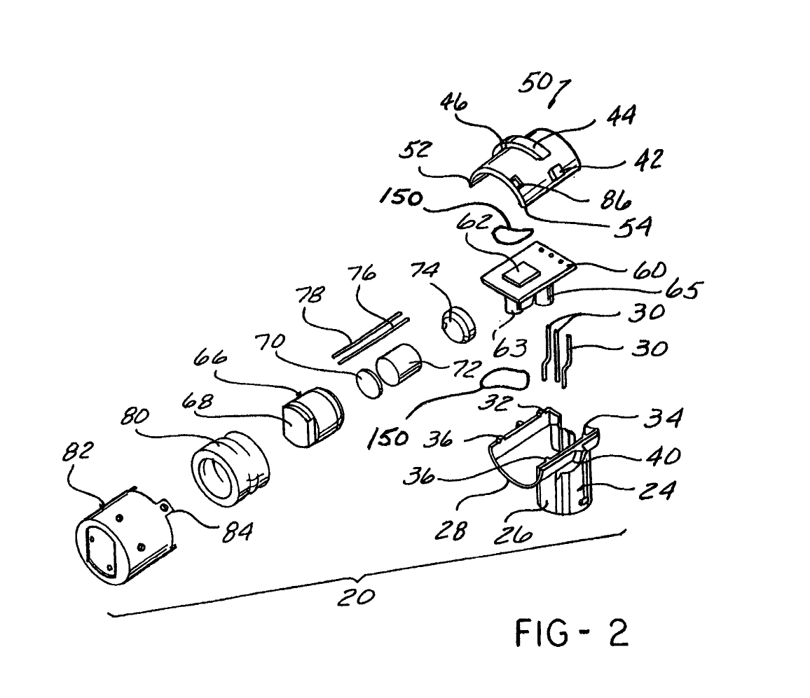

In addition, as shown in FIGS. 2-4, a plurality of co-planar ribs 40, 42, 44, 46 and 48 are co-planarly aligned and arcuately spaced about the concave portion 28 and the cover 50 when the cover 50 is engaged with the concave portion 28. The ribs 40, 44 and 48 have generally the same arcuate length and act as stops to limit insertion of the housing 20 into the mount or holder 22. The ribs 42 and 46 have a considerably smaller arcuate extent and form latch projections for latchingly receiving latch arms on the mount or holder 22, as described hereafter, to latchingly couple the holder 22 to the housing 20. At least the rib 42 has a ramp surface to assist in mounting the sensor in the holder 22.

In the first embodiment of the present invention, a printed circuit board 60 is mountable within a cavity formed between the mated cover 50 and the concave portion 28 of the base 24. The printed circuit board 60 includes connections for the terminals 30 as well as integral conductive traces extending to pin connections on an integrated circuit chip 62 which is a control device, such as microprocessor or ASIC, which executes a program for controlling the operation of the transceiver. A coil 63 is mounted on the PC board 60 and energized by the integrated circuit 62. A cap 65 adjacent to the coil 63 mounts in the base 24 to position the PC board 60 in the base 24. A thermoplastic material 150 (shown schematically in FIG. 2) fills the interior cavity between the cover and the concave portion 28 to surround and sealingly position the printed circuit board 60 within housing 20.

The integrated circuit 62 forms, shapes and amplifies signals with suitable circuitry to receive an echo signal reflected from an object detected in the range of the transceiver to a digital signal and then transmitting the digital signal to an external controller, such as a vehicle electronic control unit, via the terminals 30. Processing of the signal to determine the distance to the detected object is preferably done by the vehicle electronic control unit.

A membrane 66 preferably formed of machined aluminum has a generally cylindrical shape with a hollow interior bounded by an open end and an opposed closed end surface 68. The closed end surface 68 is machined to a flat surface and is preferably anodized. Mounted within the membrane is a sequential arrangement of a resonating ceramic disc, such as a piezoelectric disc 70, which engages an inner surface of the closed end surface 68 of the membrane 66 to transmit ultrasonic signals therethrough, a dampening element 72, a resilient or rubber plug 74 which closes the open end of the membrane 66, and a pair of wires 76 and 78 which connect the disc 70 to the integrated circuit 62.

After the disc 70, the dampener 72 and the plug 74 securely mounted within the membrane 66, the membrane 66 is inserted into an additional dampening ring 80, also formed of rubber, by example only. The ring 80 and the membrane 66 are then securely mounted within a cap 82.

In the first embodiment of the present invention, the cap 82 has one or more axially extending fingers 84, each with an interior aperture positioned to engage projections 86 on the end cover 50 and the concave portion 28 to releasably couple the cap 82 to the cover 50 and base 24.

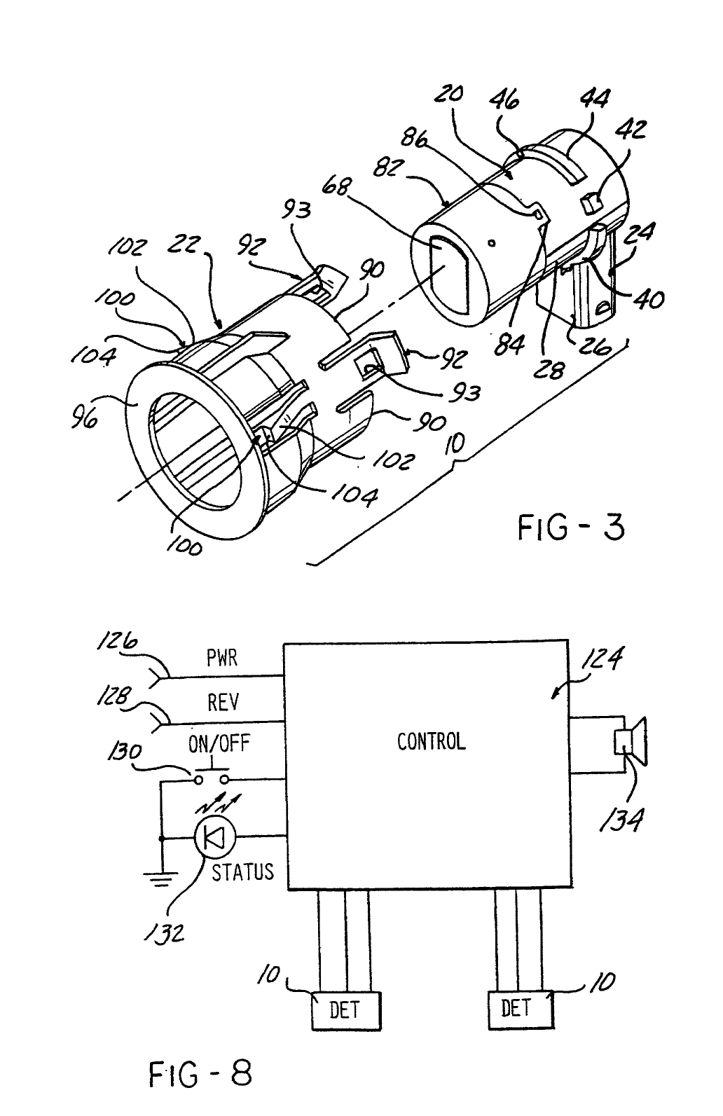

As shown in FIG. 3, when the components are assembled within the end cap 82, the end face 68 of the membrane 66 engages the disc 70 which, when energized by the circuit 60, resonances and generates a signal which passes through and is shaped by the end surface 68 to form an ultrasonic wave.

The mounting means 22 is preferably in the form of a holder, also depicted by reference number 22, which releasably mounts the transceiver 20 to a fixed support, such as in an aperture formed in the bumper 16 of a vehicle 14 as shown in FIGS. 1 and 6.

The mounting means or holder 22, as shown in detail in FIGS. 3-7, is in the form of a generally cylindrical body having opposed ends and a through bore sized to receive the end cap 82. The first end of the holder 22 defines an annular edge 90 which is interrupted by at least one and preferably a plurality of two or more latch arms 92. Further, as shown in FIG. 4, an elongated key slot 94 with outward tapered ends is formed in the holder 22 and designed to slidably receive the key projection 36 on the base 24 to align the holder 22 with the transceiver housing 20. The annular edges 90 are adapted to engage the ribs 40, 44 and 48 on the transceiver housing 20 to limit the insertion of the housing into the holder 22.

When the annular edges 90 engage the ribs 40, 44 and 48, the latch arms 92, each of which has an aperture 93 at an outer end, engages the shorter ribs 42 and 46 in a snap together connection to releasably interlock the holder 22 and the housing 20. It is seen in FIGS. 3, 5 and 6 that each latch arm 92 is spaced from adjacent portions of the body of the holder 22 by slots which position each latch arm 92 in a cantilevered manner from one end of the latch arm 92 integrally joined to the body of the holder 22 to enable each latch arm 92 to be urged radially outward upon initial engagement with the ribs 42 and 46 on the body 20. The holder 22 can be disconnected from the body 20 by outward force on the outer ends of the latch arms 92 sufficient to disengage the apertures 93 in each latch arm 92 from the respective ribs 42 and 46 on the body 20.

As shown in FIGS. 3-7, an enlarged diameter flange or bezel 96 is formed at an opposite end of the body of the holder 22 from the latch arms 92. The outer diameter of the bezel 96 is larger than the inner diameter of an aperture or bore 98 formed in the support surface, such as the vehicle bumper 16, to which the exterior object detector 10 is to be mounted, as shown in FIG. 6. At least one, and preferably a plurality, such as three, equicircumferentially spaced mounting arms 100 are carried on the body of the holder 22. Each mounting arm 100 is substantially identically constructed and includes a resilient arm integrally joined at one end to the body of the holder 22 and extending to an opposite end disposed adjacent to, but freely movable with respect to the bezel 96. Each mounting arm includes a tapered outer, raised surface 102 which terminates in an edge 104 spaced from the bezel 96. An annular slot or groove is formed between the bezel 96 and the edges 104 of each mounting arm 100 which is sized to the thickness of the support, such as the vehicle bumper 16, to which the holder 22 is mounted, as shown in FIG. 6.

The holder 22, in one example, can be mounted to the support surface or bumper 16 prior to connection to the transceiver housing 20. With reference to FIG. 6, the holder 22 is urged through the bore 98 in the support surface or bumper 16 until the bezel 96 contacts the outer surface of the bumper 16. During such insertion, the inner edges of the bumper 16 surrounding the bore 98 therein, engage and radially inward push the mounting arms 100 until the edges 104 of the mounting surface on each mounting arm 100 clear the inner surface of the bumper 16. At this time, each mounting arm 100 snaps outward capturing the bumper 16 between the edges 104 and the bezel 96. The transceiver housing 20 may then be coupled to the holder 22 to complete the vehicle exterior object detector 10 of the present invention. Alternately, the housing 20 can be mounted in the holder 22 prior to mounting the holder 22 in the bumper 16.

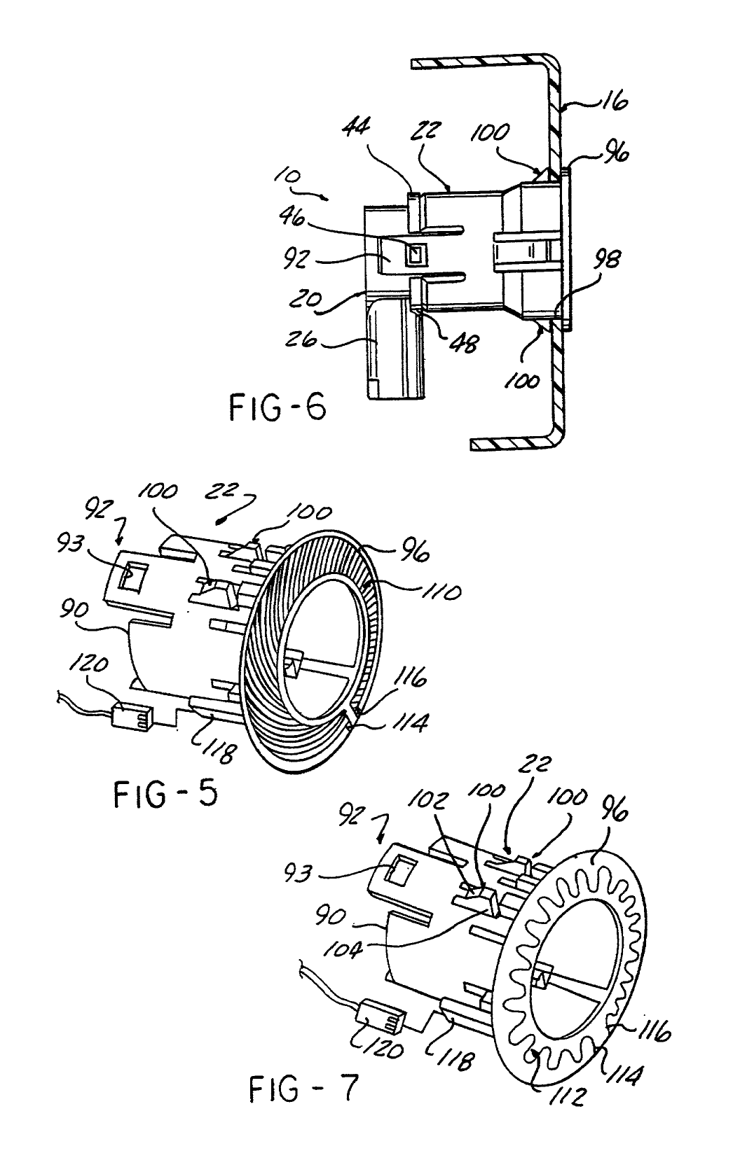

According to a unique feature of the present invention, as shown in one embodiment in FIG. 5, a means is provided for elevating the temperature of the holder 22 and, in particular, the bezel 96 to remove any snow or ice build up on the exterior end surface 68 of the membrane 66.

In the embodiment shown in FIGS. 5 and 7, the temperature elevating means is in the form of a heater means carried on the bezel 96. Preferably, the heater means, in the embodiment shown in FIG. 5, is in the form of a resistive grid or carbon film 110 which is integrally molded in the bezel 96 during the formation of the bezel 96 or afterwards by surface treatment of the bezel 96, such as via an electroplating process which forms a molded insert connect device (MID). The resistive grid or film 110 is disposed near the outer surface of the bezel 96.

In an alternate embodiment shown in FIG. 7, the temperature elevating means is in the exemplary form of a resistive wire 112 which is formed in a generally serpentine path on the bezel 96 by electroplating, insert molding, etc. Both of the resistive grid 100 and the wire 112 have opposed ends 114 and 116 which extend as conductive traces on the exterior surface of the bezel 96 and the body of the holder 22 to a suitable electrical termination or terminal 118 shown in both FIGS. 5 and 7. The terminal 118 may be an electrically conductive pad receiving a separate electrical connector 120 or an outwardly projecting contact which receives a snap on electrical connector 120. In this manner, an electrical circuit is completed from an exterior power source, such as a vehicle battery, to the resistive grid 110 or to the resistive wire 112.

Referring briefly to FIG. 8, there is depicted a control used with the vehicle exterior object detector 10. The control 124 is a dedicated electrical circuit or microprocessor based device receiving an electrical power input 126, a vehicle movement or engine running signal, such as a reverse input signal 128 when the vehicle is moving rearwardly in reverse gear or a forward input signal on forward vehicle movement within a preset speed range, an on/off switch 130, as well as a status input, such as an LED 132, indicating the on or off status of the exterior object detector 10.

The control 124 provides outputs to each of the detectors 10 mounted on the rear and/or front bumper of the vehicle. Specifically, the control 124 provides electrical power, a ground and a single wire for providing a control signal to activate each detector 10 to transmit a signal as well as providing a return path for the reflected signal where an object is detected within the range of any of the detectors 10.

An audible sound generator 134 is driven by an output signal from the control 124 and generates a sequence of audible sounds, such as successive beeps at a frequency or rate dependent on the distance to an object detected within the range of a detector. The control 124 provides a series of pulses to the sound generator 134 at a frequency whose attenuation rate increases as the distance between the vehicle and the detected object decreases. It will be evident that the sound generator 134 may be used with or replaced by a light display which can generate flashing lights, the frequency of which are dependent upon the distance to the detected object or a series of spaced lights, each corresponding to incremental distances.

Although not shown, a temperature sensor may be input to the control 124 or holder 24 to provide an ambient temperature signal. This will enable the control 124 to activate the temperature elevating means when the ambient temperature is below a preset temperature, such as 40° F.

A further preferred embodiment is predicated upon the unexpected discovery that a thermoplastic material can be successfully and advantageously used within a housing 20 formed of components such as base 24 and cover 50 without requiring the use of a curable thermosetting material as a potting compound.

As such, it has been found that thermoplastic material 150 may comprise a suitable injection moldable thermoplastic such as nylons and engineered polyesters. If desired or required, the thermoplastic may include suitable reinforcement materials, for example glass, and various minerals such as mica. The use of injection moldable thermoplastic material is advantageous for many reasons, a few of which are mentioned here.

Typically in applications such proximity sensors, object detectors and the like, conventional potting compounds have been used. Conventional potting compounds used within housings such as housing 20 typically require a curing step to initiate and promote cross linking or curing. This cross linking or curing is typically achieved by steps such as heat curing or exposure to UV radiation. Traditional thermoset potting materials such as heat cured polyurethanes and the like must be cured for 4-5 hours or even 8 hours or more. Faster curing thermoset potting materials such as UV-curable thermosetting resins are difficult to employ in many situations because UV radiation must be able of contacting the polymer in order to be cause curing to occur. Thus, while substitution of UV curable potting compounds for heat curable ones eliminates a costly manufacturing step (heating) and saves considerable time which can translate into considerable cost savings, there is still a long-felt need to find effective materials which will reduce or eliminate processing steps while not compromising the efficiency and function of the resulting object sensor device. Thermoplastic materials of the present invention can achieve this desired end result.

Additionally, thermoplastic material provides flexibility so as to prevent cracking and undesirable release of component(s) and/or exposure of the components to the environment. The thermoplastic material is also functional over a wide range of temperatures.

In the preferred embodiment, the thermoplastic material employed as an overmolding composition is an injection moldable thermoplastic selected from the group consisting of thermoplastic polyamides, thermoplastic polyesters, thermoplastic polyurethanes, acetate resins, and mixtures thereof. Thermoplastic polyamides are particularly useful in the overmolding composition. Most preferred of the thermoplastic polyamides are those selected from the group consisting of Nylon 6,6, Nylon 6,12 and mixtures thereof Also within the purview of this invention are copolymers of Nylon 6,6 or 6,12 with other suitable polyamides such as Nylon 6. Thermoplastic polyesters are a second class of materials which are particularly useful in the present invention. Among the preferred thermoplastic polyesters include those selected from the group consisting of polyethylene terepthalates, polybutylene terepthalates, and mixtures thereof.

Thermoplastic polyamides which are most particularly suited for use in the overmolding composition of the present invention are polyamide 6,12 compositions. Suitable polyamide materials are available from commercial sources; for example from Dupont under the trade name ZYTEL.

Typical properties of various polyamides for use in the present invention are set forth in Tables I and II below.

In the preferred embodiment, the polyamide material such as polyamide 6,6 or polyamide 6,12 is glass reinforced and heat stabilized. Typical glass reinforcement is in the range between about 10% and about 50% by polymeric composition weight; with glass content in the range between about 25% and about 40% being preferred. Examples of suitable glass reinforced polyamide 6.12 which can be employed in the present invention include ZYTEL FE 5355, 5382, and 5389 commercially available from Dupont Corporation. ZYTEL FE 5355, 5382, and 5389 are 33% glass reinforced, heat stabilized polyamide 6,12 resins. Various formulations are commercially available to meet processing needs such as dimensioned stability, encapsulation, etc.

TABLE 1
PROPERTIES OF SELECTED POLYAMIDE MATERIALS

| | | | | PA 66, unreinforced | | PA 66 30% glass | |
|---|---|---|---|---|---|---|---|
| | | | | Zytel ® E103 | HSL | Zytel ® 70G30 | HSL |
| Property | Test Conditions | Method ISO | Units | DAM | 50% RH | DAM | 50% RH |
| Stress at break | | .527 | MPa | 87 | 59 (yield) | 208 | 135 |
| Strain to break | | .527 | % | 4 4 | 26 (yield) | 3 | 5 |
| Tensile Modulus | | .527 | MPa | 3100 | 1500 | 10000 | 7500 |
| Charpy notched | 23° C. | 179/1eA | KJ/m² | 6 | 14 | 16 | 16 |
| Impact Strength | −30° C. | | | 4 | 4 | 14 | 16 |
| Charpy Impact | 23° C. | 179/1eU | Kj/m² | NB | NB | 88 | 97 |
| strength | −30° C. | | | NB | NB | 80 | 73 |
| Melting temperature | 10K/min | 3146C | ° C. | | 263 | | 261 |
| Temperature of | Method A, 1 8MPa | 75 | ° C. | 80 | | 254 | |
| deflection | | | | | | | |
| underload | Method B, 0 45 Mpa | | | 235 | | 260 | |
| Coefficient of linear | Parallel | ASTM | 10⁴K⁻¹ | | 1 17 | 0 | |
| thermal expansion | Normal | E813 | | | 1 14 | 1 07 | 1 07 |
| Comparative tracking | | IEC 112 | V | 525 | | 400 | |
| Electric strength | P25/P75, 1 mm | IEC243 | kV/mm | 31 | 28 | 38 | 32 |
| Surface resistivity | | IEC93 | ohm | E14 | E13 | >E15 | E13 |
| Volume resistivity | | IEC93 | ohm cm | E15 | E11 | >E15 | E11 |
| Density | | | g/ml | 1 14 | 1 14 | 1 37 | 1 37 |
| Flammability | 1 6 mm | UL94 | | V2 | V2 | HB | HB |
| Water absorption | 23° C. equillibrium | 62 | % | 2.9 | | 1.9 | |
| | 23° C. saturation | | | 8.5 | | 6 | |
| | 24 hrs immersion | | | | | | |
| Moulding shrinkage | Parallel | | | 1.5 | | 0 3 | |
| | Normal | | | | | 1 1 | |

| | PA 66 13% | | PA 6, | | PA 66/6 | | PA 66, | |
|---|---|---|---|---|---|---|---|---|
| | glass toughened | | 15% glass | | Copolymer flame retardant | | 25% glass flame retardant | |
| | Zytel ® 79G13L | | Zytel ® G15 | | Zytel ® FR7200 | VOF | Zytel ® FR70G25 | VO |
| | | | | | | 50% | | |
| Property | DAM | 50% RH | DAM | 50% RH | DAM | RH | DAM | 50% RH |

| | | | | | | | | |
|---|---|---|---|---|---|---|---|---|
| Stress at break | 118 | 67 | 135 | 75 | 85 | 50 | | |
| | | | | | | (yield) | 138 | 110 |
| Strain to break | 4 | 10 | 3 5 | 8 | 4 | 20 | 2 0 | 2 6 |
| Tensile Modulus | 5100 | 3700 | 6000 | 3500 | 3900 | 1800 | 9500 | 7500 |
| Charpy notched | 8 | 14 | 8 | 14 | 3.5 | 10.5 | 10 | — |
| Impact Strength | 6 | 6 | 8 | 14 | 3 | 3 | 9 | — |
| Charpy Impact | 67 | 59 | 57 | 85 | 50 | NB | 43 | — |
| strength | 59 | 54 | 57 | 54 | 65 | 65 | 45 | — |
| Melting temperature | | 262 | | 223 | | 255 | | |
| Temperature of | 242 | | 204 | | 75 | | 243 | |
| deflection | 260 | | 220 | | 195 | | | |
| underload | 0.5 | 0.5 | 0.38 | 0.38 | 0.78 | | 0.26 | |
| Coefficient of linear | 1.3 | 1.3 | 1.2 | 1.2 | 0.9 | | 0.83 | |
| thermal expansion | 475 | | | | 600 | | 350 | |
| Comparative tracking | 37 | 35 | | | | | | |
| Electric strength | >1E15 | E14 | | | | | | |
| Surface resistivity | >1E15 | E12 | | | >1E15 | | | |
| Volume resistivity | 1.21 | 1.21 | 1.23 | 1.23 | 1.19 | 1.19 | 1.49 | |
| Density | HB | HB | HB | HB | VO(0.5 mm) | | VO(0.5 mm) | |
| Flammability | 2.2 | | 2.5 | | | | 0.9 | |
| Water absorption | 6.5 | | 7.6 | | | | 3.4 | |
| Moulding shrinkage | 0.4 | | 0.3 | | 1.1 | | 0.23 | |

| | PA 66/6 blend, | |
|---|---|---|
| | 40% mineral, | |
| | toughened | |
| | MINLON ® 11C140 | |
| Property | DAM | 50% RH |
| Stress at break | 87 | 56 |
| Strain to break | 10 | 26 |
| Tensile Modulus | 6000 | 2400 |
| Charpy notched | 6 | 7 |
| Impact Strength | 5 | 4 |
| Charpy Impact | 120 | NB |
| strength | 80 | 80 |
| Melting temperature | | 255 |
| Temperature of | | 147 |
| deflection | | 220 |
| underload | | 0 86 |
| Coefficient of linear | | |
| thermal expansion | | 0.86 |
| Comparative tracking | 550 | |
| index | | |
| Electric strength | 36 | 27 |
| Surface resistivity | | E14 |
| Volume resistivity | | E11 |
| Density | 1.46 | 1.46 |
| Flammability | HB | HB |
| Water absorption | 1.8 | |
| | 5.7 | |
| Moulding shrinkage | 1.4 | |
| | 1.4 | |

TABLE II
PROPERTIES OF SELECTED THERMOPLASTIC MATERIALS

| | | | | PA 66, unreinforced | | PA 66 30% glass | |
|---|---|---|---|---|---|---|---|
| | | | | Zytel ® E103 | HSL | Zytel ® 70G30 | HSL |
| Property | Test Conditions | Method ISO | Units | DAM | 50% RH | DAM | 50% RH |
| Stress at break | | .527 | MPa | 87 | 59 (yield) | 208 | 135 |
| Strain to break | | .527 | % | 4 4 | 26 (yield) | 3 | 5 |
| Tensile Modulus | | .527 | MPa | 3100 | 1500 | 10000 | 7500 |
| Charpy notched | 23° C. | 179/1eA | KJ/m² | 6 | 14 | 16 | 16 |
| Impact Strength | −30° C. | | | 4 | 4 | 14 | 16 |
| Charpy Impact | 23° C. | 179/1eU | Kj/m² | NB | NB | 88 | 97 |
| strength | −30° C. | | | NB | NB | 80 | 73 |
| Melting temperature | 10K/min | 3146C | ° C. | | 263 | | 261 |
| Temperature of | Method A, 1 8MPa | 75 | ° C. | 80 | | 254 | |
| deflection | | | | | | | |
| underload | Method B, 0 45 Mpa | | | 235 | | 260 | |
| Coefficient of linear | Parallel | ASTM | 10⁴K⁻¹ | | 1 17 | 0 | |
| thermal expansion | Normal | E813 | | | 1 14 | 1 07 | 1 07 |
| Comparative tracking | | IEC 112 | V | 525 | | 400 | |
| index | | | | | | | |
| Electric strength | P25/P75, 1 mm | IEC243 | kV/mm | 31 | 28 | 38 | 32 |
| Surface resistivity | | IEC93 | ohm | E14 | E13 | >E15 | E13 |
| Volume resistivity | | IEC93 | ohm cm | E15 | E11 | >E15 | E11 |
| Density | | | g/ml | 1 14 | 1 14 | 1 37 | 1 37 |
| Flammability | 1 6 mm | UL94 | | V2 | V2 | HB | HB |
| | 0 8 mm | | | | | | |
| Water absorption | 23° C. equillibrium | 62 | % | 2.9 | | 1.9 | |
| | 23° C. saturation | | | 8.5 | | 6 | |
| | 24 hrs immersion | | | | | | |
| Moulding shrinkage | Parallel | | | 1.5 | | 0 3 | |
| | Normal | | | | | 1 1 | |

| | PA 6,12,33% | | PBT, 30% glass | PBT, 30% glass | PET, 30% |
|---|---|---|---|---|---|
| | glass | | toughened | toughened, flame ret | glass |
| | Zytel ® FE538Z | | | | |
| | | | CRASTIN ® | CRASTIN ® | |
| Property | DAM | 50% RH | T805 | T845 FR | RYNITE ® 530 |
| Stress at break | 165 | 140 | 100 | 110 | 158 |
| Strain to break | 5 | 5 | 4 2 | 3.7 | 3 |
| Tensile Modulus | | | 7000 | 8500 | 11000 |
| Charpy notched | | | 14.5 | 11 | 11 |
| Impact Strength | | | 12 6 | 10 | 11 |
| Charpy Impact | | | 77 | 56 | 70 |
| strength | | | 89 | 65 | 45 |
| Melting temperature | | 217 | 213 | 210 | 254 |
| Temperature of | 210 | | 190 | 192 | 224 |
| deflection | | | | | |
| underload | | | 205 | 205 | |
| Coefficient of linear | | | 0.3 | 0 3 | 0 3 |
| thermal expansion | | | 1.2 | 1 2 | 250 |
| Comparative tracking | | | 500 | 275 | 35 |
| index | | | | | |
| Electric strength | | | 29 | 27 | 35 |
| Surface resistivity | 1E15 | | >E14 | >E14 | E14 |
| | | | >E16 | >E16 | E15 |
| Volume resistivity | 1E15 | | >E14 | >E14 | E14 |
| | | | >E16 | >E16 | E15 |
| Density | 1 32 | | 1 50 | 1 69 | 1.56 |
| Flammability | HB | HB | HB | VO | |
| | | | HB | | HB |
| Water absorption | 0.9 | | 0.14 | 0 10 | 0 2 |
| | 2 | | 0.35 | 0 27 | 0.78 |
| | | | | | 0 05 |
| | | | | | 3 4 |
| Moulding shrinkage | | | 0.25 | 0.25 | 0.2 |
| | | | 0 7 | 0.9 | 0.9 |

| | PET, 15% glass |
|---|---|
| | toughened |
| Property | RYNITE ® 415 HP |
| Stress at break | 79 |
| Strain to break | 5 |
| Tensile Modulus | 4700 |
| Charpy notched | 11 |
| Impact Strength | 8 |
| Charpy Impact | 55 |
| strength | 25 |
| Melting temperature | 250 |
| Temperature of | 207 |
| deflection | |
| underload | |
| Coefficient of linear | 0 23 |
| thermal expansion | |
| Comparative tracking | |
| index | |
| Electric strength | |
| Surface resistivity | E13 |
| | E13 |
| Volume resistivity | E13 |
| | E13 |
| Density | 1 39 |
| Flammability | |
| | HB |
| Water absorption | 0 25 |
| | 2.5 |
| | 0 24 |
| | 5 7 |
| Moulding shrinkage | 0.3 |
| | 1 0 |

Another class of polymer suitable for use in the overmolding composition of the present invention, are injection moldable thermoplastic polyesters selected from the group consisting of polybutylene terepthalate (PBT), polyethylene terepthalate (PET), and mixtures thereof Thermoplastic polyethylene terepthalate is particularly suited for use in the present invention and is commercially available from various sources such as duPont under the tradename RYNITE. Typical properties are listed in Tables I and II.

In the preferred embodiment, PET is reinforced with a material such as glass with a range of glass reinforcement between about 10% and about 55% being typical and reinforcement between 20% and 40% glass being preferred. Examples of suitable glass reinforced PET materials which can be employed in the present invention include RYNITE 530, RYNITE 830 and RYNITE 5220 as well as RYNITE electrical specialty resins.

In the first embodiment of the present invention, components of the housing 20 such as base 24 and cover 50 are separately formed of a suitable polymeric material. In the preferred version of this first embodiment the base 24 and cover 50 are constructed from a suitable polyamide selected from the group consisting of nylon 6,6, nylon 6,12 and mixtures thereof Typically these components are premolded prior use in the general process of the present invention. Polymeric materials suitable for construction of the base 24 and cover 50 are commercially available from various sources including Dupont, under the trade name ZYTEL 70633 HSIL as well as material available under the trade name WELLMAN PA6.6 33% GR. In this first embodiment, it is to be understood that cap 82 may also be optionally formed from a suitable thermoplastic such as those mentioned.

In assembling the sensor 10 of this embodiment, the various component pieces built up and positioned in the housing 20 formed from the base 24, cap 82 and cover 50. The housing 20 is, then, positioned vertically and molten injection moldable thermoplastic compound introduced into the hollow housing interior through aperture 152 formed in base 24 in the direction of arrow A as depicted in FIG. 2.

Molten thermoplastic overmolding compound is introduced into the hollow interior of housing 20 at a temperature compatible with the circuitry contained therein. The compound temperature is that sufficient to facilitate effective introduction into the interior; namely sufficiently high to reduce fluid viscosity and provide an adequately flowable material capable of successful introduction into the hollow interior and around the various electronic component contained therein. However, the temperature is low enough as to protect delicate circuits and solder. Preferably the temperature of the injection moldable thermoplastic at introduction into the mold is between about_and about_° C. is employed with a temperature between about_and about_° being most preferred. The melt flow index of suitable materials is between about_and about_.

Molten thermoplastic is introduced at a rate and pressure suitable to fill all voids within the housing. In order to ensure equalization of forces on electrical wires 76, 78 during introduction of the molten thermoplastic, the housing has at least two gates 154, 156, preferably located in cap 50 proximate to the junction with cover 82, through which additional molten thermoplastic can be introduced.

The second embodiment of the present invention is predicated on the unexpected discovery that injection moldable thermoplastic material can be successfully and advantageously used to encase electronic proximity sensor components in a manner which eliminates the necessity of a separate preformed base and cap.

In the second embodiment, an electronic assembly composed of wires 30, circuit board 60, circuit chip 62, coil 63 and cap 65 are inserted into a suitably configured mold (not shown). The membrane assembly composed of membrane 66, resonating ceramic disc such as piezoelectric disc 72, rubber plug 74, wires 76, 78, dampening ring 80 and mounting cap 82 are insert molded to the electronic assembly during the molding process.

Suitable thermoplastic materials are selected from the group consisting of thermoplastic polyamides, thermoplastic polyesters and mixtures thereof. Suitable materials were enumerated previously in conjunction with the first preferred embodiment.

In summary, there has been disclosed a unique means for elevating the temperature of a vehicle exterior object sensor which is capable of removing any snow and/or ice build up on the sensor which could interfere with or render the sensor inoperable. The temperature elevating means is integrally carried on the holder which mounts the sensor to a support surface on a vehicle thereby providing a simple, integral assembly with a minimal number of separate components.

There has also been disclosed an object sensor with overmolded thermoplastic material employed therewith. The thermoplastic material can be positioned within a suitable housing or may be employed as an encapsulating material insert molding suitable optic sensor covers and the like. The thermoplastic materials may optionally contain amounts of pre-and/or post consumer regrind material in amounts up to about_% by weight with amounts between about_and about_% by weight being preferred. In so doing, the material cost per pat can be reduced. Use of a thermoplastic material eliminates the time and energy required to achieve curing of thermosetting resin.

While preferred embodiments, forms and arrangements of parts of the invention have been described in detail, it will be apparent to those skilled in the art that the disclosed embodiments may be modified. Therefore, the foregoing description is to be considered exemplary rather than limiting, and the true scope of the invention is that defined in the following claims.

What is claimed is:

1. A sensor, comprising:
transceiver means for transmitting a signal and receiving a return signal reflected off of an object within a range of the transceiver means;
a thermoplastic compound surrounding and directly contacting a portion of at least the transceiver means, the thermoplastic compound selected from the group consisting of thermoplastic polyamides, thermoplastic polyesters, acetal resins, and mixtures thereof.

2. The sensor of claim 1 wherein the thermoplastic polyamide is selected from the group consisting of nylon 6,6, nylon 6,12, and mixtures thereof.

3. The sensor of claim 1 wherein the thermoplastic polyester is selected from the group consisting of polyethylene terepthalate, polybutylene terepthalate, and mixtures thereof.

4. The sensor of claim 3 wherein the thermoplastic polyamide is selected from the group consisting of nylon 6,6, nylon 6,12, and mixtures thereof.

5. The sensor of claim 1 wherein the thermoplastic compound is reinforced with a suitable inorganic reinforcement compound selected from the group consisting of glass, mica, and mixtures thereof.

6. The sensor of claim 1 further comprising a housing disposed around and in intimate contact with the thermoplastic compound.

7. The sensor of claim 6 wherein the housing is composed of polymeric material selected from the group consisting of polyamides, polyesters, and mixtures thereof.

8. The sensor of claim 7 wherein the polymeric material employed in the housing is conductive, the conductivity being in a large range between about _and about_.

9. An object detection apparatus comprising:
transceiver means for transmitting a signal and receiving a return signal reflected off of an object within a range of the transceiver means;
a polymeric compound surrounding the transceiver means, the polymeric compound composed of a thermoplastic selected from the group consisting of polyamides, polyesters, acetal resins, and mixtures thereof,
means for mounting the transceiver means on a support, the mounting means including a holder coupled to the transceiver means, the holder having an end facing exteriorly of an exterior surface of the support and disposed adjacent an end of the transceiver means; and
heating means, carried by the end of the holder, for elevating the temperature of at least the end portion of the transceiver means to remove meltable material disposed on the transceiver means.

10. The object detection device of claim 9 wherein the polymeric compound is a thermoplastic selected from the group consisting of nylon 6,6, nylon 6,12, polybutylene terepthalate, polyethylene terepthalate, acetal resins, and mixtures thereof.

11. The object detection device of claim 11 wherein the polymeric compound contains between about 10% and about 55% by weight glass reinforcement material.

12. The object detection device of claim 11 further comprising a housing disposed around and in contact with the polymeric compound, the housing composed of impact-resistant, environment-resistant polymeric material.

13. The object detection device of claim 13 wherein the impact-resistant, environment-resistant polymeric material of the housing is selected from the group consisting of injection moldable polyamides, injection moldable polyesters, acetal resins, and mixtures thereof.

14. An object detection apparatus comprising:
transceiver means for transmitting a signal and receiving a return signal reflected off an object within a range of the transceiver means;
a polymeric compound surrounding and in intimate contact with the transceiver means, the polymeric compound composed of a thermoplastic material selected from the group consisting of nylon 6,6, nylon 6,12, polyethylene terepthalate, and mixtures thereof.

15. The object detection apparatus of claim 16 wherein the polymeric compound is a thermoplastic polyamide is selected from the group consisting of nylon 6,6, nylon 6,12, and mixtures thereof.

16. The object detection apparatus of claim 16 further comprising a housing disposed around and in intimate contact with the thermoplastic compound wherein the housing is composed of polymeric material selected from the group consisting of polyamides, polyesters, and mixtures thereof.
